(19) United States
(12) Patent Application Publication
(10) Pub. No.: US 2009/0111873 A1
(43) Pub. Date: Apr. 30, 2009

(54) Novel Zeta-Cypermethrin Composition

(75) Inventors: Hylsa Garcia, Elizabeth, NJ (US); Hui S. Yang, Plainsboro, NJ (US)

Correspondence Address: PATENT ADMINISTRATOR;FMC CORPORATION, 1735 MARKET STREET, PHILADELPHIA, PA, 19103, US

(73) Assignee: FMC Corporation, Philadelphia, PA (US)

(21) Appl. No.: 12/302,129

(22) PCT Filed: Jun. 27, 2007
(86) PCT No.: PCT/US07/72201

§ 371 Date: Nov. 24, 2008

Related U.S. Application Data
(60) Provisional application No. 60/818,056, filed on Jun. 30, 2006.

(51) Int. Cl. A01N 37/34; A01P 7/04

(52) U.S. Cl. 514/521

(57) ABSTRACT

The present invention is directed to an insecticidal composition comprising zeta-cypermethrin: a) prepared by an epimerization process, and b) containing a residual amount of an epimerization catalyst, and glycerine, wherein the zeta-cypermethrin is present in an insecticidally effective amount and to methods of using the composition.

This application claims the benefit of U.S. Provisional Application No. 60/818,056, filed Jun. 30, 2006.

### FIELD OF THE INVENTION

The present invention relates to the field of insecticides and chemical formulations. In particular, the invention provides a novel insecticidal formulation of zeta-cypermethrin that is physically stable.

### BACKGROUND OF THE INVENTION

To enable the efficient elimination or controlling of unwanted insects in agriculture and related endeavors, it is desirable to use effective chemical insecticides on these unwanted pests. Formulations containing insecticides are desirable in agricultural and related endeavors in order to effectively distribute the active ingredient to the area that insect control is desired. Physical stability is most important in this type of formulation in order to ensure the small amount of the insecticide is fully effective. When applying formulated insecticides, environmental concerns such as the amount of volatile organic compounds exposed to the atmosphere also need to be addressed.

The cyano-pyrethroid zeta-cypermethrin is a potent and quick acting insecticide, which controls a broad spectrum of chewing, sucking and flying insects. A problem in the art of formulating zeta-cypermethrin, prepared by the epimerization process disclosed in U.S. Pat. No. 4,997,970, is in successfully achieving physical stability of the formulation over significant periods of time. Typically, in commercial applications, the insecticidal formulation comprises less than one percent of the tank mixture to keep the cost of the formulation low, while still yielding spectrum and onset of visual symptomology benefits. The physical stability of the formulation when diluted with water in commercial applications is a key problem in the art.

The commercially available formulation of zeta-cypermethrin prepared by a different process than the epimerization process referred to above (Mustang Max 0.8EW®, available from FMC Corporation) requires the use of both a thickener, i.e., xanthan gum, and an antifreeze agent, i.e., propylene glycol, along with an aromatic solvent, emulsifiers, an antifoam agent, a preservative and water. If zeta-cypermethrin prepared by the above-referenced epimerization process is used in this formulation, it results in the formation of a precipitate, and upon dilution in water, flocculation occurs.

### SUMMARY OF THE INVENTION

In accordance with the present invention, it has now been found that a novel EW (emulsion—oil in water) formulation of zeta-cypermethrin (zeta-cypermethrin prepared by the epimerization process disclosed in U.S. Pat. No. 4,997,970) including glycerine as a combination thickener and antifreeze agent solves the problem of precipitate formation and flocculation when diluted with water. Specifically, the present invention is directed to a stable insecticidal composition comprising zeta-cypermethrin (zeta-cypermethrin prepared by the epimerization process disclosed in U.S. Pat. No. 4,997,970) and glycerine as a thickener and antifreeze agent. The use of glycerine significantly improves physical stability and eliminates the need for additional thickening and antifreeze agents. Use of the formulation of the present invention provides a production cost advantage as well as environmental benefits because lower amounts of volatile organic compounds may be employed.

### DETAILED DESCRIPTION OF THE INVENTION

The present invention is directed to a novel EW (emulsion—oil in water) formulation of zeta-cypermethrin (zeta-cypermethrin prepared by the epimerization process disclosed in U.S. Pat. No. 4,997,970) which includes glycerine as a thickener/antifreeze agent. Specifically, the present invention is directed to an insecticidal composition comprising zeta-cypermethrin (zeta-cypermethrin prepared by the epimerization process disclosed in U.S. Pat. No. 4,997,970) and glycerine, wherein the zeta-cypermethrin insecticide is present in an insecticidally effective amount.

The term “zeta-cypermethrin” as used herein means (R,S)-α-cyano-3-phenoxybenzyl-(1RS)-cis-trans-3-(2,2-dichlorovinyl)-2,2-dimethylcyclopropanecarboxylate which has been enriched in the 1R-cis-S and 1R-trans-S isomers by the epimerization process disclosed in U.S. Pat. No. 4,997,970. In particular it refers to the cypermethrin isomer mixture prepared by the epimerization of a 55/45 cis/trans mixture of cypermethrin with a catalytic amount of a catalyst such as tricaprylmethylammonium chloride (Aliquat® 336, Aldrich Chemical Co.) and sodium carbonate in n-heptane. The epimerization process and subsequent isolation procedure produces a cypermethrin which is enriched in the more insecticidally active isomers, commonly termed “zeta-cypermethrin” but which also contains a small residual amount, usually 0.6% to 1.3% of the catalyst used in the epimerization process, i.e., an epimerization catalyst. The presence of the catalyst, a cationic compound, causes the formulation difficulties, for example, the formation of precipitates and flocculation.

The zeta-cypermethrin active ingredient is preferably present in a concentration from 0.0012% to 40% by weight, preferably from 10% to 35% by weight, more particularly, from 20% by weight to 27% by weight based upon the total weight of all components in the composition.

The glycerine is preferably a refined glycerine, for example, Agnique GLY 99-U glycerine, available from Cognis Corporation. Glycerine is present in an amount from 3% to 20% by weight, preferably from 6% to 16% by weight of all the components in the total formulation.

The insecticidal composition may further comprise additional components selected from an aromatic or aliphatic solvent, a nonionic polymeric surfactant, a polyalkylene glycol ether, an antifoam agent, a preservative and water.

Preferably, the aromatic solvent is selected from alkylated naphthalene aromatic and alkylated naphthalene depleted aromatic, for example, Aromatic 200, available from Exxon Chemical Americas. The aromatic solvent is present in an amount from 1% to 50% by weight, preferably from 10% to 30% by weight, more preferably from 13% to 17% by weight of all components in the total formulation.

Preferably, the nonionic polymeric surfactant is one or more surfactants selected from the group consisting of an alkyd polyethylene glycol, for example, Atlox 4914, available from Uniqema Corporation and; a polyalkylene glycol ether, for example, Atlas G-5000, available from Uniqema Corporation; a polyglycol polymer, for example, Tersperse 2520 and Termul 5429, both available from Huntsman Corporation. The nonionic polymeric surfactant is present in a total concentration from 3% to 20% by weight preferably from 6% to 12% of all components in the total formulation.

The anti-foam agent is an alkylcyclotetrasiloxane, preferably an octamethylcyclotetrasiloxane, silicone emulsion, for example, Dow Corning AF Emulsion, available from Dow Corning Corporation. The anti-foam agent is present in an amount from 0.001% to 1% by weight of all the components in the total formulation.

The preservative is preferably an isothiazolone mixture, for example, Kathon CG/ACP preservative or Legend MK preservative, both available from Rohm and Haas Corporation. The preservative is present in an amount of from 0.001% to 1% by weight of all the components in the total formulation.

Water is used as a diluent and preferably is purified water, for example, deionized or distilled water, and is present in an amount that would dilute the active ingredient to a desired concentration.

A preferred embodiment of the invention is an insecticidal composition wherein zeta-cypermethrin is present in an amount from 20% to 27%, the aromatic solvent is present in an amount from 13% to 17%, the nonionic polymeric surfactants are present in an amount from 6% to 12%, glycerine is present in an amount from 6% to 16%, the anti-foam agent is present in an amount from 0.001% to 1%, the preservative is present in the amount from 0.001% to 1% and water is present in an amount sufficient to provide the desired concentration of the active ingredient, wherein all %'s are % by weight based upon the total weight of all the components in the composition.

The term “ambient temperature” as utilized herein shall generally mean any suitable temperature found in a laboratory or other working quarter, and is generally not below about 15° C. nor above about 30° C. The abbreviation “% by wt” means percent by weight. The abbreviation “lb/ga” means pounds per gallon.

The formulation of the present invention is further illustrated by the examples below. The examples serve only to illustrate the invention and should not be interpreted as limiting since further modifications of the disclosed invention will be apparent to those skilled in the art. All such modifications are deemed to be within the scope of the invention as defined in the claims.

### EXAMPLE 1

### This Example Illustrates One Protocol for the Preparation of a 0.8 lb/ga Zeta-Cypermethrin Emulsion of Oil in Water Formulation of the Present Invention Containing 5% by Weight Glycerine (Formulation Code F1)

Into a first reaction vessel equipped with a Krimkmana Polytron PT300 homogenizer and a mechanical stirrer was added 80.6 grams (45.12% by wt) of deionized water, 0.2 grams (0.1% by wt) of octamethylcyclotetrasiloxane, silicone emulsion (Dow Corning AF Emulsion) and 10.7 grams (6.0% by wt) of polyalkylene glycol ether (Atlas G-5000). The mixture was stirred with a mechanical stirrer and heated to a temperature of between 50° C. and 70° C. Into a second reaction vessel equipped with a mechanical stirrer was added 25.0 grams (15.42% by wt) of alkylated naphthalene depleted aromatic solvent (Aromatic 200), 45.9 grams (25.68% by wt) of zeta-cypermethrin (35.9% purity) and 7.1 grams (4.0% by wt) of alkyd polypropylene glycol (Atlox 4914). This mixture was stirred and heated to between 50° C. and 70° C. until a homogenous solution formed. While maintaining a reaction temperature of between 50° C. and 70° C., the homogenizer attached to the first reaction vessel was turned on at a speed of about 2,000 RPM and the solution from the second reaction vessel was added slowly. Upon complete addition, the homogenizer speed was increased to between 9,000 and 10,000 RPM and a small sample of the mixture was removed and analyzed to determine the particle size distribution using a particle size distribution analyzer (Horiba Particle Scattering Particle Size Distribution Analyzer LA-910). The mixture was stirred and homogenized until a particle size of less than 3 microns was obtained, at which time the homogenizer was turned off. Glycerine (8.9 grams, 5.0% by wt) and a preservative (Legend MK, 0.2 grams, 0.1% by wt) were added and the stirred mixture was allowed to cool to ambient temperature. The mixture was transferred into storage bottles and the bottles were sealed. One bottle was maintained in an oven at 54° C. for two weeks. Analysis of the formulated material indicated no particulate formation and a stable particle distribution.

### EXAMPLE 2

### This Example Illustrates One Protocol for the Preparation of a 0.8 lb/ga Zeta-Cypermethrin Emulsion of Oil in Water Formulation of the Present Invention Containing 5% by Weight Glycerine (Formulation Code F2)

Into a first reaction vessel equipped with a Krimkmana Polytron PT300 homogenizer and a mechanical stirrer was added 80.6 grams (45.12% by wt) of deionized water, 0.2 grams (0.1% by wt) of octamethylcyclotetrasiloxane, silicone emulsion (Dow Corning AF Emulsion) and 10.7 grams (6.0% by wt) of polyglycol polymer (Termul 5429). The mixture was stirred with a mechanical stirrer and heated to a temperature of between 50° C. and 70° C. Into a second reaction vessel equipped with a mechanical stirrer was added 25.0 grams (15.42% by wt) of alkylated naphthalene depleted aromatic solvent (Aromatic 200), 45.9 grams (25.68% by wt) of zeta-cypermethrin (35.9% purity) and 7.1 grams (4.0% by wt) of polyglycol polymer (Tersperse 2520). This mixture was stirred and heated to between 50° C. and 70° C. until a homogenous solution formed. While maintaining a reaction temperature of between 50° C. and 70° C., the homogenizer attached to the first reaction vessel was turned on at a speed of about 2,000 RPM and the solution from the second reaction vessel was added slowly. Upon complete addition, the homogenizer speed was increased to between 9,000 and 10,000 RPM and a small sample of the mixture was removed and analyzed to determine the particle size distribution using a particle size distribution analyzer (Horiba Particle Scattering Particle Size Distribution Analyzer LA-910). The mixture was stirred and homogenized until a particle size of less than 3 microns was obtained, at which time the homogenizer was turned off. Glycerine (8.9 grams, 5.0% by wt) and a preservative (Legend MK, 0.2 grams, 0.1% by wt) were added and the stirred mixture was allowed to cool to ambient temperature. The mixture was transferred into storage bottles and the bottles were sealed. One bottle was maintained in an oven at 54° C. for two weeks. Analysis of the formulated material indicated no particulate formation and a stable particle distribution.

### EXAMPLE 3

### This Example Illustrates One Protocol for the Preparation of a 0.8 lb/ga Zeta-Cypermethrin Emulsion of Oil in Water Formulation of the Present Invention Containing 6% by Weight Glycerine (Formulation Code F3)

Into a first reaction vessel equipped with a Krimkmana Polytron PT300 homogenizer and a mechanical stirrer was added 44.12% by wt of deionized water, 0.1% by wt of octamethylcyclotetrasiloxane, silicone emulsion (Dow Corning AF Emulsion) and 6.0% by wt of polyalkylene glycol ether (Atlas G-5000). The mixture was stirred with a mechanical stirrer and heated to a temperature of between 50° C. and 70° C. Into a second reaction vessel equipped with a mechanical stirrer was added 15.73% by wt of alkylated naphthalene depleted aromatic solvent (Aromatic 200), 23.95% by wt of zeta-cypermethrin (38.5% purity) and 4.0% by wt of alkyd polypropylene glycol (Atlox 4914). This mixture was stirred and heated to between 50° C. and 70° C. until a homogenous solution formed. While maintaining a reaction temperature of between 50° C. and 70° C., the homogenizer attached to the first reaction vessel was turned on at a speed of about 2,000 RPM and the solution from the second reaction vessel was added slowly. Upon complete addition, the homogenizer speed was increased to between 9,000 and 10,000 RPM and a small sample of the mixture was removed and analyzed to determine the particle size distribution using a particle size distribution analyzer (Horiba Particle Scattering Particle Size Distribution Analyzer LA-910). The mixture was stirred and homogenized until a particle size of less than 3 microns was obtained, at which time the homogenizer was turned off. Glycerine (6.0% by wt) and a preservative (Legend MK, 0.1% by wt) were added and the stirred mixture was allowed to cool to ambient temperature. The mixture was transferred into storage bottles and the bottles were sealed. One bottle was maintained in an oven at 54° C. for two weeks. Analysis of the formulated material indicated no particulate formation and a stable particle distribution.

### EXAMPLE 4

### This Example Illustrates One Protocol for the Preparation of a 0.8 lb/ga Zeta-Cypermethrin Emulsion of Oil in Water Formulation of the Present Invention Containing 16% by Weight Glycerine (Formulation Code F4)

In a manner similar to Example 3, the combination of 34.12% by wt of deionized water, 0.1% by wt of octamethylcyclotetrasiloxane, silicone emulsion (Dow Corning AF Emulsion) and 6.0% by wt of polyalkylene glycol ether (Atlas G-5000), 15.73% by wt of alkylated naphthalene depleted aromatic solvent (Aromatic 200), 23.95% by wt of zeta-cypermethrin (38.5% purity), 4.0% by wt of alkyd polypropylene glycol (Atlox 4914), 16.0% by wt glycerine and a preservative (Legend MK, 0.1% by wt) formed formulation F4. The formulation was transferred into storage bottles and the bottles were sealed. One bottle was maintained in an oven at 54° C. for two weeks. Analysis of the formulated material indicated no particulate formation and a stable particle distribution.

### EXAMPLE 5

### This Example Illustrates One Protocol for Testing the Dilution Stability of 0.8 lb/ga Zeta-Cypermethrin Emulsion of Oil in Water Formulations

The dilution stability of each formulation was conducted by adding 2.5 mL of the formulation to 47.5 mL of water with 342 ppm hardness in a 50 mL Nessler tube. The Nessler tube was sealed with a rubber stopper and the contents mixed by inverting the tube ten times. The Nessler tube was placed in a tube rack at ambient temperature and the percent separation and presence of flocculate was recorded at 2.0 hours and 4.0 hours. The percent separation was calculated by first measuring the height of the separation, if any, then the total height of the mixture. Dividing the separation height by the total height and multiplying by 100 provides the percent separation. The novel formulations of the present invention maintained the physical stability (zero separation) without flocculate formation.

Table 1 below sets forth the results of visual analysis of the formulations prior to and after dilution with water.

TABLE 1
Stability Data for the Formulations of the Present Invention

| | | Storage | Particle Size (microns) | | | | % Separation When Diluted | |
|---|---|---|---|---|---|---|---|---|
| Formulation | Storage Time | Temperature | 90% | 50% | % | Sedimentation | With Water | |
| Code (F#) | (Weeks) | (° C.) | distribution | distribution | Separation | Present | (2 Hour)* | (4 Hour)* |
| F1 | 0 | 23 | 1.3 | 0.6 | 0 | None | 0 | 0 |
| F1 | 2 | 54 | 0.5 | 0.3 | 0 | None | 0 | 0 |
| F2 | 0 | 23 | 0.7 | 0.4 | 0 | None | 0 | 0 |
| F2 | 2 | 54 | 0.4 | 0.3 | 0 | None | 0 | 0 |
| F3 | 0 | 23 | 1.9 | 1.2 | 0 | None | 0 | 0 |
| F3 | 2 | 54 | — | — | 0 | None | 0 | 0 |
| F4 | 0 | 23 | 3.5 | 2.1 | 0 | None | 0 | 0 |
| F4 | 2 | 54 | 3.0 | 1.9 | 0 | None | 0 | 0 |

*No flocculation was observed at 2 hours and 4 hours

While this invention has been described with an emphasis upon preferred embodiments, it will be understood by those of ordinary skill in the art that variations of the preferred embodiments may be used and that it is intended that the invention may be practiced otherwise than as specifically described herein. Accordingly, this invention includes all modifications encompassed within the spirit and scope of the invention as defined by the following claims.

What is claimed is:

1. An insecticidal composition comprising:
a) zeta-cypermethrin; and
b) glycerine;
wherein said zeta-cypermethrin contains an epimerization catalyst.

2. The composition of claim 1 wherein the epimerization catalyst is tricaprylmethylammonium chloride.

3. The composition of claim 2 wherein the amount of catalyst is from 0.6% to 1.3% by weight based on the total weight of the composition.

4. The composition of claim 1 wherein zeta-cypermethrin is present in a concentration from 20% to 27% by weight based on the total weight of all the components in the composition.

5. The composition of claim 1 wherein glycerine is present in an amount from 6% to 16% by weight of all the components in the total composition.

6. The composition of claim 1 further comprising one or more aromatic or aliphatic solvent.

7. The composition of claim 6 wherein the aromatic solvent is selected from alkylated naphthalene aromatic solvent and alkylated naphthalene depleted aromatic solvent.

8. The composition of claim 7 wherein the aromatic solvent is present in a concentration from 13% to 17% by weight based on the total weight of all the components of the composition.

9. The composition of claim 1 further comprising nonionic polymeric surfactants.

10. The composition claim 9 wherein the nonionic polymeric surfactants are selected from the group consisting of an alkyd polyethylene glycol and a polyalkylene glycol ether.

11. The composition of claim 10 wherein the total concentration of the alkyd polyethylene glycol and the polyalkylene glycol ether surfactant is from 6% to 12% by weight based upon the total weight of all the components in the composition.

12. The composition of claim 1 further comprising an antifoam agent.

13. The composition of claim 12 wherein the anti-foam agent is present in an amount from 0.001% to 1% by weight of all the components in the total formulation.

14. The composition of claim 1 further comprising a preservative.

15. The composition of claim 14 wherein the preservative is present in an amount from 0.001% to 1% by weight of all the components in the total formulation.

16. A method for controlling unwanted insects comprising applying a composition of claim 1 to a locus where insects are present or are expected to be present.

17. An insecticidal composition comprising:
a) zeta-cypermethrin containing an epimerization catalyst present in a concentration from 20% to 27%;
b) an aromatic solvent present in a concentration from 13% to 17%;
c) an alkyd polyethylene glycol and a polyalkylene glycol ether present in a total concentration from 6% to 12%;
d) glycerine present in an amount from 6% to 16%;
e) an anti-foam agent present in an amount from 0.001% to 1%; and
f) a preservative present in an amount from 0.001% to 1%;
wherein all % are % by weight based on the total weight of all the components in the formulation.

18. A method for controlling unwanted insects comprising applying a composition of claim 17 to a locus where insects are present or are expected to be present.
